(19) United States
(12) Patent Application Publication
(10) Pub. No.: US 2022/0065148 A1
(43) Pub. Date: Mar. 3, 2022

(54) Mixer and Exhaust Aftertreatment System

(71) Applicant: Faurecia Emission Control Technologies (Shanghai) Co., Ltd, Shanghai (CN)

(72) Inventors: Fabien SUDRIES, Gyeonggi-do (KR); Fabrice GIACOMIN, Gyeonggi-do (KR); Ludovic GEANT, Shanghai (CN); Vijaykumar MADEGOWDA, Bangalore (IN); Rajeev NAIK, Bangalore (IN)

(21) Appl. No.: 17/466,860

(22) Filed: Sep. 3, 2021

(30) Foreign Application Priority Data
Sep. 3, 2020 (CN) 202021907890.1

(51) Int. Cl. F01N 3/28; F01N 3/20

(52) U.S. Cl. CPC F01N 3/2892; F01N 3/2066; F01N 2610/1453; F01N 2570/14; F01N 2610/02; F01N 2240/20

(57) ABSTRACT

A mixer comprises an exhaust intake channel (the side wall of which comprises an injection opening, and which provides a first mixing chamber); a flow distributor in the first mixing chamber and comprising a first and second flow path area; a first and second endcaps; and a deflector. The first and second endcaps are oppositely closed to form a second mixing chamber comprising an inlet and outlet portion that are not concentrically arranged. The inlet portion is connected to the first mixing chamber. The deflector is at the second mixing chamber. The first flow path area, the deflector, and the side wall of the outlet portion form a first flow path. The second flow path area and the side wall of the second mixing chamber form a second flow path. The downstream ends of the first and second flow paths merge at the outlet portion of the second mixing chamber.

### CROSS-REFERENCE TO RELATED APPLICATIONS

This application claims priority to Chinese Application No. 202021907890.1 filed Sep. 3, 2020, the disclosure of which is incorporated herein by reference in its entirety and for all purposes.

### TECHNICAL FIELD

The present disclosure relates to the field of exhaust aftertreatment, and in particular to a mixer and an exhaust aftertreatment system.

### BACKGROUND ART

The engine exhaust aftertreatment system treats the hot exhaust generated by the engine by various upstream exhaust aftertreatment components to reduce emissions pollutants. Various upstream exhaust aftertreatment components may include one or more of the following components: tubes, filters, valves, catalysts, muffler and so on. For example, the upstream exhaust treatment components guide the exhaust to a selective catalytic reduction (SCR) catalyst having an inlet and outlet, and the outlet will output the exhaust to downstream exhaust aftertreatment components. A mixer is positioned upstream of the inlet of the SCR catalyst. In the mixer, the exhaust generates a swirling movement. A doser is used to inject a reducing agent such as urea solution on the upstream of the SCR catalyst to the exhaust so that the mixer can fully mix the urea and the exhaust together and output to the SCR catalyst to run the reduction reaction producing nitrogen and water, so as to reduce the nitrogen oxide emission of the engine.

In the mixer, the urea solution droplets injected from the doser need to sufficiently decompose and uniformly mix with the exhaust, so as to avoid urea deposit, and the mixer should also generate sufficient swirling movement, so the reactant can be uniformly attached to the surface of the catalyst in the SCR catalyst.

But for the space arrangement of a vehicle, the space reserved for the exhaust aftertreatment system is smaller and smaller, and the requirements for the compactness of the exhaust aftertreatment system are more, and the exhaust aftertreatment system should be fit the installation of other components. So the exhaust aftertreatment system needs to be compact, but that might cause the reducing agent and the exhaust are not able to be fully mixed in the mixer, and the mixer is not able to generate a strong enough swirling moving, affecting the reaction efficiency in the SCR catalyst.

### SUMMARY

One objective of the present invention is to provide a mixer.

Another objective of the present invention is to provide an exhaust aftertreatment system.

A mixer according to one aspect of the present invention is for use in an vehicle exhaust aftertreatment system. The mixer comprises: an exhaust intake channel, and the side wall of the exhaust intake channel comprising an injection opening, and the exhaust intake channel providing a first mixing chamber; a flow distributor positioned in the first mixing chamber and comprising a first flow path area and a second flow path area; a first endcap; a second endcap; and a deflector; wherein the first endcap and the second endcap are set to be oppositely closed to form a second mixing chamber, and the second mixing chamber comprises an inlet portion and an outlet portion that are not concentrically arranged, and the inlet portion is connected to the first mixing chamber, and the deflector is positioned at the second mixing chamber, and the first flow path area, the deflector and the side wall of the outlet portion form a first flow path, and the second flow path area and the side wall of the second mixing chamber form a second flow path, and the downstream end of the first flow path and the downstream end of the second flow path merge at the outlet portion of the second mixing chamber.

In one or more embodiments of the mixer, the deflector is positioned between the inlet portion and the outlet portion of the second mixing chamber.

In one or more embodiments of the mixer, the deflector is an arc-shaped deflecting plate, and the inlet portion of the second mixing chamber is positioned at the side where the center of the arc is, a part of the side wall of outlet portion of the second mixing chamber used for forming the first flow path is tangent to the arc-shaped deflecting plate or an extending arc therefrom; and wherein the mixer provides a theoretical cylinder defined by a variable radius extending outwardly from a center axis of the inlet portion of the second mixing chamber, and wherein the variable radius is defined larger than the radius range of the inlet portion, and the arc-shaped deflecting plate is tangent to the theoretical cylinder.

In one or more embodiments of the mixer, the gap between the side wall of the outlet portion of the second mixing chamber and the side wall of the mixing chamber is gradually narrower and narrower in a first direction, and the first direction is the direction that the inlet portion points to the outlet portion of the second mixing chamber.

In one or more embodiments of the mixer, the first flow path area comprises a first airfoil, and the second flow path area comprises a second airfoil, wherein the first airfoil comprises a first flow direction structure, and the second airfoil comprises a second flow direction structure.

In one or more embodiments of the mixer, the first airfoil and the second airfoil are in a shape of a flat plate, and the angle between the extending direction of the first airfoil and the axial direction of the exhaust intake channel is a first angle, and the angle between the extending direction of the second airfoil and the axial direction of the exhaust intake channel is a second angle.

In one or more embodiments of the mixer, the inlet portion and the outlet portion of the second mixing chamber is on the same end of the second mixing chamber.

In one or more embodiments of the mixer, the mixer further comprises a mounting seat used for mounting a doser, and the angle α between the axis of the mounting seat and the axis of the exhaust intake channel is 0°<α<90°.

In one or more embodiments of the mixer, the angle α between the axis of the mounting seat and the axis of the exhaust intake channel is 20°<α<70°.

An exhaust aftertreatment system according to another aspect of the present invention comprises any one of the mixers as described above, and a doser, wherein the doser injects a reducing agent solution through the injection opening into the exhaust intake channel.

In one or more embodiments of the exhaust aftertreatment system, the reducing agent is a urea solution.

In one or more embodiments of the exhaust aftertreatment system, the exhaust aftertreatment system further comprises a SCR catalyst and a turbocharger, wherein the SCR catalyst is directly connected to the outlet portion of the second mixing chamber, and the turbocharger is directly connected to an inlet portion of the exhaust intake channel.

The present invention may include, but is not limited to, the beneficial effects that through the setting of the flow distributor and the deflector, the first flow path and the second flow path are formed in the mixer, so that the exhaust and the reducing agent can be fully mixed in the narrow space of the mixing chamber formed by the first endcap and the second endcap, and form a strong enough swirling movement on the outlet portion, so that the mixed exhaust and the reducing agent can be uniformly attached to the catalyst of the SCR catalyst, guaranteeing the treatment of the nitrogen oxides of the exhaust. Meanwhile, the technical solutions of the present invention will not increase the backpressure, and can be suitable for SCR catalysts of various structures, so that the exhaust aftertreatment system can be suitable for different requirements of space arrangement of a vehicle.

### BRIEF DESCRIPTION OF THE DRAWINGS

The above-mentioned and other features, properties and advantages of the present invention will become more apparent from the following description in conjunction with the accompanying drawings and the embodiments. It is to be noted that the accompanying drawings are merely examples, which are not drawn to scale, and should not be construed as limiting the scope of protection actually claimed by the present invention, and in the accompanying drawings:

FIG. 1 is a structural schematic diagram of an exhaust aftertreatment system according to one embodiment.

FIG. 2 is a structural schematic diagram of a mixer according to one embodiment.

FIG. 3 is a partial structural schematic diagram based on FIG. 1.

FIG. 4A and FIG. 4B are structural schematic diagrams of relative position of the deflector to the inlet portion and the outlet portion based on FIG. 2.

### DETAILED DESCRIPTION

Various different implementations or embodiments carrying out the subject matter and technical solutions are disclosed as follows. Specific examples of various elements and arrangements are described below for the purpose of simplifying the disclosure, and of course, these are merely examples and are not intended to limit the scope of protection of the present invention.

In addition, the expressions “one embodiment”, “an embodiment” and/or “some embodiments” are intended to mean a certain feature, structure, or characteristic associated with at least one embodiment of the present application. Hence, it should be emphasized and noted that “an embodiment” or “one embodiment” or “one or more embodiments” mentioned in two or more different positions in this specification does not necessarily refer to the same embodiment. Furthermore, some of the features, structures, or characteristics of one or more embodiments of the present application can be combined as appropriate.

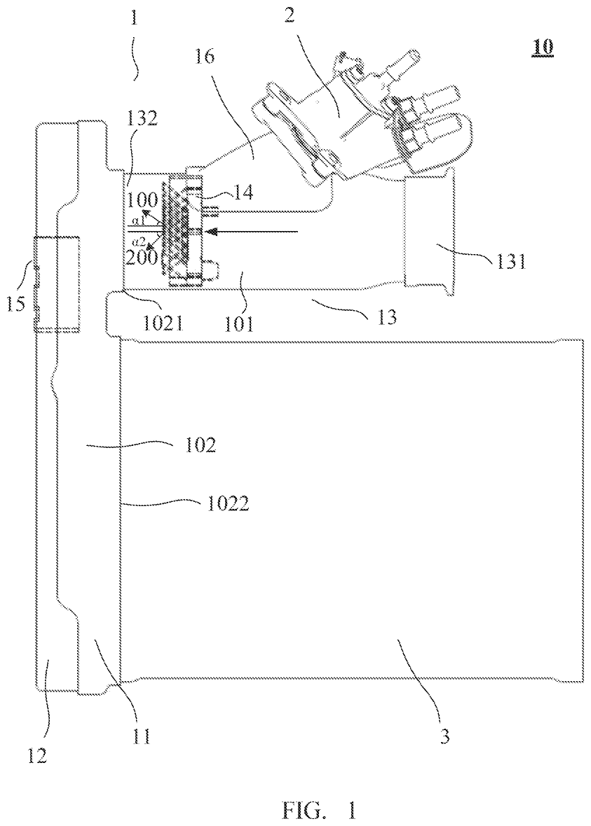

As shown in FIG. 1, the exhaust aftertreatment system 10 can comprise a mixer 1, a doser 2, an SCR catalyst 3, and the doser 2 can inject a reducing agent solution such as a urea solution into the mixer 1 and fully mixed with the exhaust and then output from the mixer 1 to the SCR catalyst 3 performing a reaction, transforming the nitrogen oxides of the exhaust into nitrogen and water. Currently, the reducing agent solution is typically the urea solution, and so in the following embodiments the reducing agent solution will be described as a urea solution.

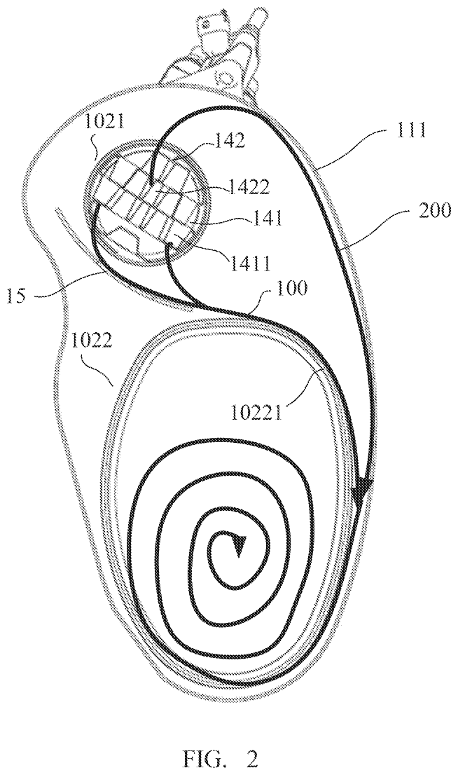

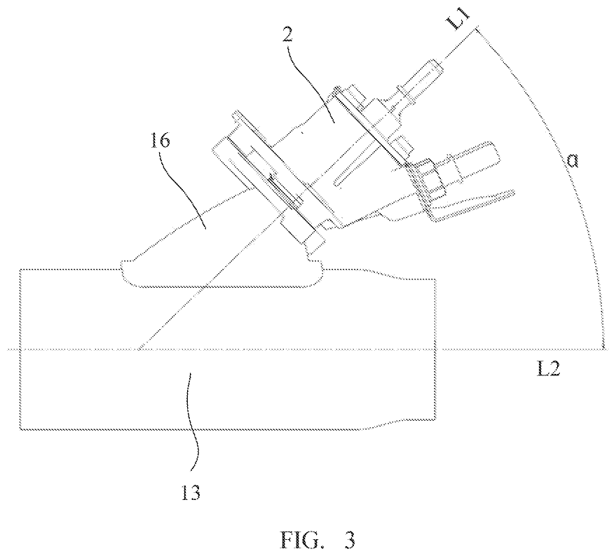

With continued reference to FIG. 1, in some embodiments, the mixer 1 can comprise a first endcap 11, a second endcap 12, an exhaust intake channel 13, a flow distributor 14, and a deflector 15. The exhaust enters the mixer 1 through the inlet portion 131 of the exhaust intake channel 13, and the side wall of the exhaust intake channel 13 comprises an injection opening, and the doser 2 injects the urea solution through the injection opening into the exhaust intake channel 13, mixed with the exhaust, so that the exhaust intake channel 13 provides a first mixing chamber 101 to mix the exhaust with the injected urea solution spray in the mixer 1. The mixer 1 can further comprise a mounting seat 16, and the mounting seat 16 is set on the injection opening, and the doser 2 is mounted on the side wall of the exhaust intake channel 13 by the mounting seat 16. As shown in FIG. 3, the injecting direction of the doser injecting the urea solution is approximately the same as the direction of the axis L1 of the mounting seat 16, and the angle α between the axis L1 of the mounting seat 16 and the axis L2 of the exhaust intake channel 13 can be 0°<α<90°, preferably 20°-70°, more preferably from 30°-60°, so that the mix of the exhaust with the urea spray can be optimized. With continued reference to FIG. 1 and FIG. 2, the first endcap 11 and the second endcap 12 are set to be oppositely closed, connecting to the outlet portion 132 of the exhaust intake channel 13 by first endcap 11, so the mixture of the exhaust with the urea spray can continue the mixing process in the closed space formed by the first endcap 11 and the second endcap 12, that is to say, the first endcap and the second endcap are set to be oppositely closed to form a second mixing chamber 102 for the mixing of the exhaust with the urea spray. As shown in FIG. 2, the second mixing chamber 102 comprises an inlet portion 1021 and an outlet portion 1022 that are non-concentric. With continued reference to FIG. 1 and FIG. 2, a flow distributor 14 is set in the exhaust intake channel 13, and the position of the flow distributor 14 can be located at the position downstream to the position that the doser 2 mounted on the exhaust intake channel 13, that is to say, downstream to the position of the injection opening, so as to distribute the mixture of the exhaust and the urea spray, distributing the exhaust and/or the mixture of the exhaust and the urea mixture into at least two flow paths to flow, for example, the first flow path 100 and the second flow path 200 shown in FIG. 1, and it can be understood that the two flow paths shown in FIG. 1 are just an example, it can form more flow paths. The flow distributor 14 comprises a first flow path area 141 and a second flow path area 142. As shown in FIG. 2, the first flow path area 141, the deflector 15 and the side wall 10221 of the outlet portion 1022 of the second mixing chamber 102 form the first flow path 100 for the mixture of the exhaust and the urea spray, and the second flow path area 142 and the side wall of the second mixing chamber 102 form the second flow path 200 for the mixture of the exhaust and the urea spray, and the downstream end of the first flow path 100 and the downstream end of the second flow path 200 merge at the outlet portion 1022 of the second mixing chamber 102. The beneficial effects of the above mentioned embodiments lie in that by setting the flow distributor 14 and the deflector 15, the first flow path 100 and the second flow path 200 are formed in the mixer 1, extending the length of the mixing path of the exhaust and the urea spray, so that the exhaust and the urea spray can be fully mixed in the narrow space of the second mixing chamber 102 formed by the first endcap 11 and the second endcap 12, and forming a strong enough swirling movement on the outlet portion 1022, so that the mixed exhaust and the reducing agent can be uniformly attached to the catalyst of the SCR catalyst, guaranteeing the treatment of the nitrogen oxides of the exhaust. Meanwhile, the technical solutions of the above mentioned embodiments will not increase the backpressure, and can be suitable for SCR catalysts of various structures, for example, as shown in FIG. 2, the shape of the outlet portion 1022 is the same as the shape of the SCR catalyst, the shape of the cross section is not an ordinary circle shape, but a near-ellipse shape, so that the exhaust aftertreatment system 10 can be suitable for different requirements of space arrangement of a vehicle, improving the versatility of the mixer 1 and the exhaust aftertreatment system 10.

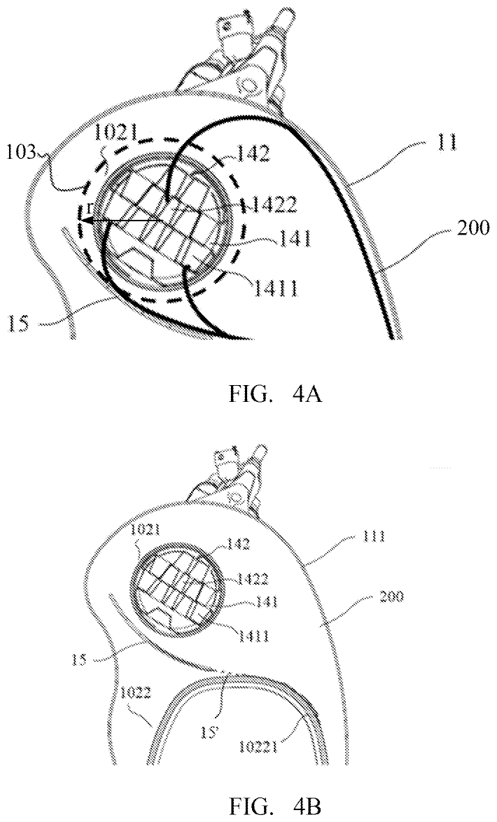

With continued reference to FIG. 2, in some embodiments, the detailed structure of the second mixing chamber 102 can be that the deflector 15 is positioned between the inlet portion 1021 and the outlet portion 1022 of the second mixing chamber 102. The detailed structure of the deflector can be an arc-shaped deflecting plate, but not limited thereto, the deflector can be of other structures and forms, for example, the deflector can be obtained by setting deflecting vanes, deflecting grooves, and so on. The beneficial effects of using an arc-shaped plate structure are easy to manufacture, and easy to match the outlet portion 1022 to get good flowing and easy to form the swirling movement. Further, the relative position of the arc-shaped deflecting plate to the inlet portion 1021 and the outlet portion 1022 can be, as shown in FIG. 4A, the mixer 1 provides a theoretical cylinder 103 defined by a variable radius extending outwardly from a center axis of the inlet portion 1021 of the second mixing chamber 102, and the variable radius is defined larger than the radius range of the inlet portion 1021, and the arc of the arc-shaped deflecting plate is tangent to the theoretical cylinder 103. And, as shown in FIG. 4B, the inlet portion 1021 is positioned at the side where the center of the arc is, the side wall 10221 of outlet portion 1022 is tangent to an extending arc 15′ extending from the arc-shaped deflecting plate, as shown in FIG. 4B that the dashed line extending from the deflector 15 is tangent to the side wall 10221, and it can be understood that, it can also be that the arc of the arc-shaped deflecting plate itself is tangent to the side wall 10221 of the outlet portion. So that the deflector 15 can at most ‘catch’ the flow that enters through the inlet portion 1021 to be deflected, and make the flow as more as possible go along the firs flow path 100, instead of directly going to the outlet portion 1022, further optimizing the effect of the swirling movement formed by the first flow path 100 on the outlet portion 1022, and because of a better deflecting effect of the deflector, the length of the deflector 15 can be as short as possible, to minimize the effect on the back pressure. With continued reference to FIG. 2, the structure that the downstream end of the first flow path 100 and the downstream end of the second flow path 200 merge at the outlet portion 1022 can be that the gap between the side wall 10221 of the outlet portion 1022 of the second mixing chamber 102 and the side wall 111 of the second mixing chamber 102 is gradually narrower and narrower in a direction that the inlet portion 1021 points to the outlet portion 1022, and the beneficial effect lies in that the structure is simple, and no need to add extra deflectors to forcedly merge the first flow path 100 and the second flow path 200 to form a strong swirling movement.

With continued reference to FIG. 1 and FIG. 2, the detailed structure of the first flow path area 141 and the second flow path area 142 can be that the first flow path area 141 comprises a first airfoil 1411, and the second flow path area 142 comprises a second airfoil 1422, and the first airfoil 1411 comprises a first flow direction structure, and the second airfoil 1422 comprises a second flow direction structure. The detailed structures of the first airfoil 1411 and the second airfoil 1422 can be, as shown in FIG. 1 and FIG. 2, plate-shaped vanes, in a shape of a flat plate, and the angle between the extending direction of the first airfoil 1411 and the axial direction of the exhaust intake channel 13 is a first angle α1, and the extending direction of the first airfoil 1411 is the first flow direction, and similarly, extending direction of the second airfoil 1422 is the second flow direction, and the angle between the extending direction of the second airfoil 1422 and the axial direction of the exhaust intake channel 13 is a second angle α2. The beneficial effect lies in that the structure of the vanes is simple, and it will be easy to adjust the flow direction of the first flow path 100 and the second flow path 200, which only needs to change the angle between the extending direction of the flat plate shaped vanes and the axial direction of the exhaust intake channel 13. It can be understood that the detailed structure of the airfoil is not limited to the above description, for example, it can be a vane with complicated curved surface, like the shape of a rotor blade of a turbocharger.

With continued reference to FIG. 1, in some embodiments, the structure of the mixer 1 can be that the inlet portion 1021 and the outlet portion 1022 of the second mixing chamber 102 is on the same end of the second mixing chamber 102, as shown in FIG. 1, it can be that the inlet portion 1021 and the outlet portion 1022 are both on the first endcap 11, and the first endcap 11 connects with the exhaust intake channel 13 and the SCR catalyst 3, to save some axial space, so that the mixer 1 and the exhaust aftertreatment system 10 can be mounted in a vehicle space arrangement with limited axial space. By using the mixer 1 of this structure, a close-coupled structure exhaust aftertreatment system 10 can be achieved, facilitating a compact arrangement for the vehicle, so that the mixer can be directly connected to the turbocharger or the exhaust manifold on the upstream, and can be directly connected to the SCR catalyst on the downstream. The reason is that, although the axial length of the mixer 1 is relatively short, because of the setting of the flow distributor 14 and the deflector 15, even if the flow is unstable from the exhaust intake channel 13, the mixer 1 in a short axial length can still obtain a good mixing performance and a strong swirling movement, so there is no need to be like in the prior arts that functional components like a Diesel Particulate Filter (DPF) is needed to be set on the upstream of the mixer to stabilize the flow, while the inlet portion 131 of the exhaust intake channel 13 can directly be connected to a turbocharger or an exhaust manifold, achieving a close-coupled structure exhaust aftertreatment system. It can be understood that if the exhaust aftertreatment system comprises a turbocharger, then the inlet portion 131 can directly be connected to the turbocharger, and if the exhaust aftertreatment system does not comprise a turbocharger, then the inlet portion 131 can directly be connected to the exhaust manifold. The ‘directly connected’ here means that there is no functional components between the mixer 1 and the turbocharger of the exhaust manifold on the upstream, or between the mixer 1 and the SCR catalyst on the downstream, but not to rule out that they are connected to short pipes or joints.

It can be seen from the above that by using the mixer and the exhaust aftertreatment system described in the above embodiments, the beneficial effects lie in that through the setting of the flow distributor and the deflector, the first flow path and the second flow path are formed in the mixer, so that the exhaust and the reducing agent can be fully mixed in the narrow space of the mixing chamber formed by the first endcap and the second endcap, and form a strong enough swirling movement on the outlet portion, so that the mixed exhaust and the reducing agent can be uniformly attached to the catalyst of the SCR catalyst, guaranteeing the treatment of the nitrogen oxides of the exhaust. Meanwhile, the technical solutions of the above embodiments will not increase the backpressure, and can be suitable for SCR catalysts of various structures, so that the exhaust aftertreatment system can be suitable for different requirements of space arrangement of a vehicle.

Although the present invention has been disclosed as the above embodiments which, however, are not intended to limit the present invention, any person skilled in the art could make possible changes and alterations without departing from the spirit and scope of the present invention. Hence, any alteration, equivalent change and modification which are made to the above-mentioned embodiments in accordance with the technical essence of the present invention without departing from the contents of the technical solutions of the present invention would all fall within the scope of protection defined by the claims of the present invention.

### REFERENCE NUMERALS

10—Exhaust aftertreatment system
1—Mixer
11—First endcap
12—Second endcap
13—Exhaust intake channel
14—Flow distributor
141—First flow path area
1411—First airfoil
142—Second flow path area
1422—Second airfoil
15—Deflector
16—Mounting seat
101—First mixing chamber
102—Second mixing chamber
111—Side wall of the second mixing chamber
1021—Inlet portion
1022—Outlet portion
10221—Side wall of the outlet portion
100—First flow path
200—Second flow path
2—Doser
3—SCR catalyst

We claim:

1. A mixer for use in a vehicle exhaust aftertreatment system, the mixer comprising:
an exhaust intake channel, and the side wall of the exhaust intake channel comprising an injection opening, and the exhaust intake channel providing a first mixing chamber;
a flow distributor positioned in the first mixing chamber and comprising a first flow path area and a second flow path area;
a first endcap;
a second endcap; and
a deflector;
wherein the first endcap and the second endcap are set to be oppositely closed to form a second mixing chamber, and the second mixing chamber comprises an inlet portion and an outlet portion that are not concentrically arranged, and the inlet portion is connected to the first mixing chamber, and the deflector is positioned at the second mixing chamber, and the first flow path area, the deflector and the side wall of the outlet portion form a first flow path, and the second flow path area and the side wall of the second mixing chamber form a second flow path, and the downstream end of the first flow path and the downstream end of the second flow path merge at the outlet portion of the second mixing chamber.

2. The mixer of claim 1, wherein the deflector is positioned between the inlet portion and the outlet portion of the second mixing chamber.

3. The mixer of claim 2, wherein the deflector is an arc-shaped deflecting plate, and the inlet portion of the second mixing chamber is positioned at the side where the center of the arc is, a part of the side wall of outlet portion of the second mixing chamber used for forming the first flow path is tangent to the arc-shaped deflecting plate or an extending arc therefrom; and wherein the mixer provides a theoretical cylinder defined by a variable radius extending outwardly from a center axis of the inlet portion of the second mixing chamber, and wherein the variable radius is defined larger than the radius range of the inlet portion, and the arc-shaped deflecting plate is tangent to the theoretical cylinder.

4. The mixer of claim 1, wherein the gap between the side wall of the outlet portion of the second mixing chamber and the side wall of the second mixing chamber is gradually narrower and narrower in a first direction, and the first direction is the direction that the inlet portion points to the outlet portion of the second mixing chamber.

5. The mixer of claim 1, wherein the first flow path area comprises a first airfoil, and the second flow path area comprises a second airfoil, wherein the first airfoil comprises a first flow direction structure, and the second airfoil comprises a second flow direction structure.

6. The mixer of claim 5, wherein the first airfoil and the second airfoil are in a shape of a flat plate, and the angle between the extending direction of the first airfoil and the axial direction of the exhaust intake channel is a first angle, and the angle between the extending direction of the second airfoil and the axial direction of the exhaust intake channel is a second angle.

7. The mixer of claim 1, wherein the inlet portion and the outlet portion of the second mixing chamber is on the same end of the second mixing chamber.

8. The mixer of claim 1, wherein the mixer further comprises a mounting seat used for mounting a doser, and the angle α between the axis of the mounting seat and the axis of the exhaust intake channel is 0°<α<90°.

9. The mixer of claim 8, wherein the angle α between the axis of the mounting seat and the axis of the exhaust intake channel is 20°<α<70°.

10. An exhaust aftertreatment system, comprising a mixer and a doser, wherein the mixer comprises:
an exhaust intake channel, and the side wall of the exhaust intake channel comprising an injection opening, and the exhaust intake channel providing a first mixing chamber;
a flow distributor positioned in the first mixing chamber and comprising a first flow path area and a second flow path area;
a first endcap;
a second endcap;
a deflector;
wherein the first endcap and the second endcap are set to be oppositely closed to form a second mixing chamber, and the second mixing chamber comprises an inlet portion and an outlet portion that are not concentrically arranged, and the inlet portion is connected to the first mixing chamber, and the deflector is positioned at the second mixing chamber, and the first flow path area, the deflector and the side wall of the outlet portion form a first flow path, and the second flow path area and the side wall of the second mixing chamber form a second flow path, and the downstream end of the first flow path and the downstream end of the second flow path merge at the outlet portion of the second mixing chamber; and the doser can inject a reducing agent solution through the injection opening into the exhaust intake channel.

11. The exhaust aftertreatment system of claim 10, wherein the deflector is positioned between the inlet portion and the outlet portion of the second mixing chamber.

12. The exhaust aftertreatment system of claim 11, wherein the deflector is an arc-shaped deflecting plate, and the inlet portion of the second mixing chamber is positioned at the side where the center of the arc is, a part of the side wall of outlet portion of the second mixing chamber used for forming the first flow path is tangent to the arc-shaped deflecting plate or an extending arc therefrom; and wherein the mixer provides a theoretical cylinder defined by a variable radius extending outwardly from a center axis of the inlet portion of the second mixing chamber, and wherein the variable radius is defined larger than the radius range of the inlet portion, and the arc-shaped deflecting plate is tangent to the theoretical cylinder.

13. The exhaust aftertreatment system of claim 10, wherein the gap between the side wall of the outlet portion of the second mixing chamber and the side wall of the second mixing chamber is gradually narrower and narrower in a first direction, and the first direction is the direction that the inlet portion points to the outlet portion of the second mixing chamber.

14. The exhaust aftertreatment system of claim 10, wherein the first flow path area comprises a first airfoil, and the second flow path area comprises a second airfoil, wherein the first airfoil comprises a first flow direction structure, and the second airfoil comprises a second flow direction structure.

15. The exhaust aftertreatment system of claim 14, wherein the first airfoil and the second airfoil are in a shape of a flat plate, and the angle between the extending direction of the first airfoil and the axial direction of the exhaust intake channel is a first angle, and the angle between the extending direction of the second airfoil and the axial direction of the exhaust intake channel is a second angle.

16. The exhaust aftertreatment system of claim 10, wherein the inlet portion and the outlet portion of the second mixing chamber is on the same end of the second mixing chamber.

17. The exhaust aftertreatment system of claim 10, wherein the mixer further comprises a mounting seat used for mounting a doser, and the angle α between the axis of the mounting seat and the axis of the exhaust intake channel is 0°<α<90°.

18. The exhaust aftertreatment system of claim 17, wherein the angle α between the axis of the mounting seat and the axis of the exhaust intake channel is 20°<α<70°.

19. The exhaust aftertreatment system of claim 10, wherein characterized in that the reducing agent is a urea solution.

20. The exhaust aftertreatment system of claim 10, wherein the exhaust aftertreatment system further comprises an SCR catalyst and a turbocharger, wherein the SCR catalyst is directly connected to the outlet portion of the second mixing chamber, and the turbocharger is directly connected to an inlet portion of the exhaust intake channel.
